(19) United States
(12) Patent Application Publication
(10) Pub. No.: US 2010/0262050 A1
(43) Pub. Date: Oct. 14, 2010

(54) Infant Soothing Support Device

(76) Inventor: Karen Gasparovich, Shelby Township, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 12/421,707

(22) Filed: Apr. 10, 2009

(51) Int. Cl. A61H 1/00; A47C 20/02

(52) U.S. Cl. 601/57; 5/655

(57) ABSTRACT

An infant soothing support device made of a resilient wedge pad, a vibrator, which will not heat up while being used, integral with the resilient wedge pad, and a cover which encases both the resilient wedge pad and the vibrator such that the vibrator is unable to vibrate loose while in use. This device capable of providing a soothing vibration to an infant while resting across or against the device for the purpose of aiding in the recovery of health issues like congestion, colic, cystic fibrosis, or any other major organ malformation which could benefit from mild movements or vibrations as well as aid in the breastfeeding process for an infant. An infant soothing support device that is extremely portable, easily packed, and not dependent upon the resting position or location of the infant.

### CROSS-REFERENCES TO RELATED APPLICATIONS

Not applicable.

### FEDERALLY SPONSORED RESEARCH OR DEVELOPMENT

Not applicable.

### REFERENCE TO A MICROFICHE APPENDIX

Not applicable.

### BACKGROUND OF THE INVENTION

1. Field of the Invention

The present invention generally relates to therapeutic cushions for infants. More specifically, this invention relates to an infant soothing support cushion which will impart controlled soothing movements to a newborn or young infant lying across or against the cushion so as in neonatal uses babies having upper respiratory problems, difficulty sleeping, or breast feeding will obtain a soothing sensation from use of said cushion.

2. Description of the Related Art

The development of new and innovative products for newborn babies and infants has addressed many special concerns when it comes to the care and nurturing of such. Many unique items have been tried and used with little to great success. Products that aid in feeding, bathing, sleeping, travel, health, and other similar areas have been the desire of new parents for many decades. These products aid in the care and nurturing of newborns and infants.

One particular area of care is the positioning and support of a newborn while sleeping. Various sleeping aids have been produced and used to help an infant sleep longer and in a safer position. These sleeping aids are more commonly known as sleeping positioners, and have been an area of considerable development over the past twenty years. These sleeping aids have been developed in response to many health conditions that newborns have become inflicted with during their time in cribs, bassinets, and other locations where an infant may sleep. Unfortunately, some of these health conditions, like Sudden Infant Death Syndrome, more commonly known as SIDS, has resulted in the loss of life. Most of these sleep positioners are made of foam or sponge material and have generally a wedge shape to them. These wedge positioners work well to keep the infant from rolling on its stomach, but do little to help comfort an ill or congested baby, as well as provide for a more sound and restful sleep.

Another area of care for infants and newborns has to do with their health. Their mother's body provides the nourishment, oxygen, and protection from the surrounding environmental conditions during the development of the fetus into a full term baby. The unborn baby hears their mother's heartbeat and voice, and movement during the day and night which calms the infant. After birth these comforting movements and sounds are much more difficult to maintain since the infant is no longer a part of the mother. Also, the mother is no longer providing oxygen to the infant, and often the infant can become ill, have congestion, or trouble breathing especially when either born prematurely and their lungs are not fully developed, or if the infant is born with any potential malformation of any critical organs.

Yet another area of care for infants and newborns has to do with their feeding. Breastfeeding is recommended by the Academy of Pediatrics (AAP), the American Medical Association (AMA), the American Dietetic Association (ADA), and the World Health Organization (WHO). A mother's natural breast milk is known to be the healthiest for an infant due to its vitamins, minerals, and natural antioxidants. Many mothers are unable to get their child to start the breast feeding activity, more commonly known as “latching on”, due to the infants lack of comfort or potential medical problems.

Ramey, U.S. Pat. No. 4,136,685, discloses a way in which one would vibrate a cushion. This patent is directed to the dampening effect of a cushion when a vibrating means is mounted within the cushion and a pressure switch is connected to the vibrating mean such that the vibrating means is engaged when a person applies pressure to the cushion and closes the pressure switch completing the electrical circuit for the vibrating means. The issue with such a device for an infant or newborn is that their mass is considerably less than older children and adults and they are not capable to depress such a pressure switch within a cushion, simply by laying across such a cushion. Also an infant may not lay still upon the pressure switch or fuss enough in which their torso would no longer depress the pressure switch and the vibrations would cease.

Rosen, U.S. Pat. No. 4,893,366, teaches the use of a mechanical vibration to reduce a child's crying. The vibration is applied to the child's place of rest by rigidly mounting a motor and imbalance to the frame or substructure and starting the device either manually or automatically. The concern with this type of device is that it takes the effort to rigidly mount such a device to the frame or substructure of the place of rest, thereby not being very portable. It also does not aid in the positioning of an infant during rest such that other potentially harmful occurrences like SIDS are reduced.

Lizama et al., U.S. Pat. No. 6,175,981, describes a portable vibrating sleeping pad which is used in combination with a sleeping surface. The sleeping pad is constructed of foam and contains a plurality of vibrating devices. The pad further contains a control unit which is affixed in a vertical manner to the rungs of a crib or the headboard of a bed to keep the control unit out of the reach of the child. The pad extends to cover the majority of a crib and the infant would lay its entire body upon the crib pad. The disadvantages of this crib pad is that the child lays completely upon the pad and that the vibration means is in contact with the child's head as well as the child's torso and limbs. Also, the crib pad needs to be mounted in a manner such that the control box will be out of the reach of the child. This will limit the potential locations and portability in which this device may be used. Finally, this pad again does not aid in the positioning of the child for sleep.

Lee et al, U.S. Pat. No. 6,647,572, discloses a cushion having a circular cylindrical shaped configuration and a plurality of vibrating motors embedded within the cushion. This configuration of the cushion would be carried in the bosom area of the body and have either a leg or arm resting upon the cushion. The disadvantage, however, is that this configuration brings the cushion close to the face of the infant and could potentially obstruct the air path of the infant, especially if the cushion moves up into the facial region of the infant. A second approach is to make the cushion or pad in a wedge shape and lay the pad behind the infant or rest the infant upon the wedge. This approach is taught by Houghteling, U.S. Pat. No. 6,877,176. The wedge portion of this Infant Support System is noted to support the entire infant upon the wedge pad and further use positioners to keep the infant from rolling off the pad. The disadvantage however is that the pad supports the entire head, torso, and limbs of the infant when laid upon the support system. One would not be able to add movement or vibration to this pad without possibly affecting the head of the infant. This movement or vibration must be limited such that one would not injury the infant, therefore this type of wedge would not be useful in helping to break up congestion or comforting a colicky baby.

From the above, it can be appreciated that solutions given in the prior references of a vibrating cushion, a vibration device mounted to a frame or substructure, a portable vibration crib pad, an infant support system and crib wedge are not fully optimized to help an infant or newborn who is having problems “latching on”, who may be ill, congested, colicky, or having problems breathing and needs to eat well and have a restful sleep to aid in the recovery of such while providing portability and ease of use for the caregiver. Therefore, what is needed is a portable and easy to use infant soothing support device which will properly position the infant while sleeping and provide mild movement and/or vibrations such that the baby is comforted as though still within the mother's womb, allow the infant a more comforted environment to “latch on” for breast feeding, and aid in the recovery of potential health issues like congestion and colic, thereby allowing the infant to sleep more soundly, eat more effectively, and recover more quickly from potential illnesses.

### SUMMARY OF THE INVENTION

According to the preferred embodiment of the present invention, there is provided an infant soothing support device which can be used with an infant or newborn to aid in sleeping, help therapeutically with congestion or colic, and calm an infant while starting to breastfeed.

The infant soothing support device is fabricated from a resilient wedge member or pad that contains an internal cavity located adjacent to the thicker end of the wedge and containing a vibrator. The wedge pad further has a pad opening that starts at the widest end of the wedge and extends into the cavity allowing direct access to the cavity for placing within or removing from there a vibrator. A cover is closely fitted to the wedge pad and has an opening within the cover which when the pad is installed within the cover, the cover opening is located directly adjacent to the pad opening. The cover opening is provided with a closure device for securely closing the opening. This closure device could include hook and loop fasteners, zippers, buttons, material folds, and the like. Furthermore, the soothing device also has a vibrator within the cavity. The vibrator cooperates with the resilient wedge pad so as to provide soothing movement or vibrations to the infant while in use. This is accomplished by turning on the vibrator and placing it within the wedge pad cavity that is within the wedge pad and cover. Then closing the cover and placing the infant upon the pad in such a manner as to have only the infant's torso laying across the pad.

The issue of an infant not having the mass to activate such a vibrating device is resolved due to the fact that the vibrating means is turned on prior to being placed within the cavity of the resilient wedge pad. The pad is placed under or next to the torso of the infant and not rigidly mounted to a frame or substructure of a crib and only the torso of the infant is in direct contact with the pad so as to reduce any vibration or movement to the head portion of the infant, while still providing a soothing therapeutic movement or vibration to the infant's torso.

Therefore, it is an object of the present invention to provide an infant soothing support device that is capable to aid in protectively positioning the infant while resting to reduce the possibilities of blocked airways or suffocation.

It is another object of the invention to provide an infant soothing support device which will provide vibration or movement in the general area of the torso area an infant thereby aiding in the healing process of congestion and colic.

It is a still another object of the invention to provide an infant soothing support device that can be used by an adult or parent holding the infant.

It is yet another object of the invention to provide an infant soothing support device that is economical

It is a further object of the invention to provide an infant soothing support device that will be portable with little or no time to setup and be independent of resting location and surroundings.

It is still a further object of the invention to provide an infant soothing support device that is easy to use.

It is yet a further object of the invention to provide an infant soothing support device that is extremely portable.

It is yet still a further object of the invention to provide an infant soothing support device that will calm an infant in the starting phases of breast feeding.

These objects and other features, aspects, and advantages of this invention will be more apparent after a reading of the following detailed description, appended claims, and accompanying drawings.

### DESCRIPTION OF THE DRAWINGS

FIG. 1 is a perspective view of an infant soothing support device.

FIG. 2 is a cross-sectional view of the infant soothing support device as taken along section line 2-2 of FIG. 1.

FIG. 3 is a cross-sectional view of the infant soothing support device along section line 2-2 of FIG. 1 now showing a square cavity shape, and the use of a hook and loop fastener with the cover.

FIG. 4 is a perspective view of the vibrator member.

### DETAILED DESCRIPTION OF THE PREFERRED EMBODIMENT

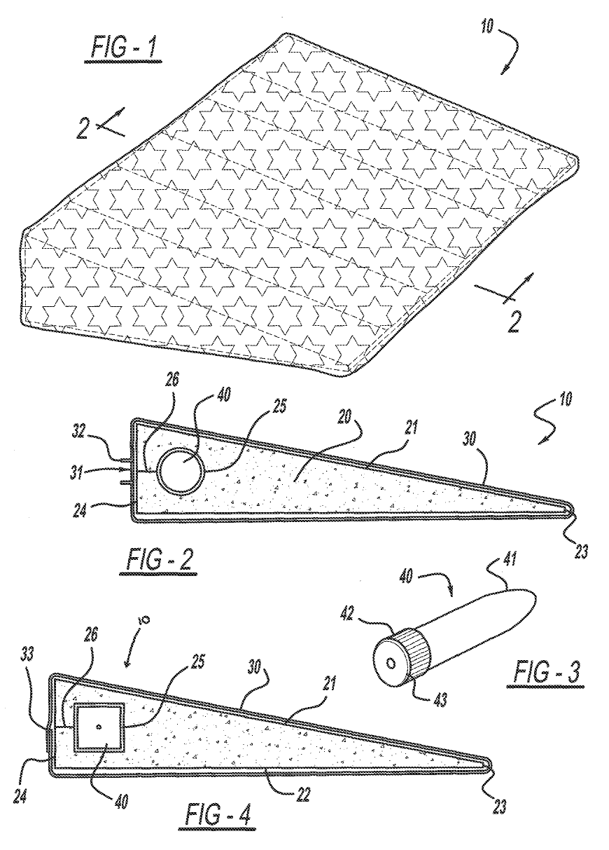

Referring now in detail to the Figures, there is shown in FIGS. 1 and 2 an infant soothing support device 10 that is constructed according to the present invention. The infant soothing support device 10 generally includes a resilient wedge pad 20, a cover 30 which is close fitting to the resilient wedge pad 20, and a vibrator 40 located within the resilient wedge pad 20 and in close proximity with the thicker side of the resilient wedge pad 20.as shown in FIG. 2. This compact configuration allows the infant soothing support device 10 to be easily packed and transported to wherever the baby may be traveling and even be used while traveling in an infant seat either in a car, train, bus, ship, or airplane.

In FIG. 2, there is shown a cross-sectional view of the infant soothing support device 10 with a resilient wedge pad 20. The resilient wedge pad 20 having an upper surface 21 and a lower surface 22 which forms an acute angle with and is opposite to the upper surface 21. Also shown in FIG. 2 is an upper surface 21 and a lower surface 22 extending from one end 23. The upper surface 21 and lower surface 22 converge toward each other as the upper surface 21 and lower surface 22 extending from one end 23 and terminate at the opposite end 24. The difference in thickness of one end 23 compared to the opposite end 24 is determined by the acute angle that the upper surface 21 makes to the lower surface 22, the distance between one end 23 and the opposite end 24, the resiliency of the sponge or foam material used for the pad 20, and the thickness and shape of the vibrator 40 that will be inserted into the cavity 25. Also shown in FIG. 2 is a cylindrical cavity 25 in the thicker end of the pad 20 containing a vibrator 40. This cavity is not limited to a cylindrical shape. The cavity may have various shapes and sizes dependent upon the shape and size of the vibrator 40 and the shape and size of the resilient wedge pad 20. The cylindrical cavity 25 is in communication with the face of the opposite end 24 through a pad opening 26 or slit in the foam material. The pad opening 26 is such that a user is able to insert and remove the vibrator 40 from the cylindrical cavity 25 within the resilient wedge pad 20, thereby allowing the user to access and activate/deactivate and adjust the vibrator 40 when necessary.

Also shown is a cover 30 surrounding the resilient wedge pad 20 in a close-fit manner. The cover 30 is in the form of a pocket with a cover opening 31, such that the resilient wedge pad 20 can be removed and re-inserted within the cover 30 through the cover opening 31, to allow the user to clean the cover 30 without damaging the resilient wedge pad 20. The cover 30 has a zipper 32 mounted about the periphery of the cover opening 31 such that the cover 30 may repeat ably be opened and closed freely for the purposes of removing the resilient wedge pad 20 when cleansing the cover 30 or accessing the vibrator 40 through the pad opening 26 of the resilient wedge pad 20. Although the preferred embodiment discloses a zipper 32 for the purposes of opening and closing the cover opening 31, any type of reusable fastener system such as buttons, hook and loop fasteners, or the like may be used.

FIG. 4 shows an alternative section from line segment 2-2 in which the cavity 25 within the pad 20 is in the shape of a square, and the closure of the cover is shown using a hook and loop fastener 33

FIG. 3 shows a perspective view of the vibrator 40. The vibrator has a body 41, a cover 42 which is attached to one end of the body 41. The cover 42 provides access to the inside of the body 41 where a battery is housed and connected to provide energy for the vibrator 40 during operation. The cover 42 further contains a speed control 43. The speed control 43 allows the user to modify the frequency of the vibrator 40, thereby allowing the user to select the desired motion and intensity that the infant using the device will experience. The vibrator herein described was purchased from a retail facility in which any person can procure one similar to it from a similar retail facility. The characteristics of the vibrator which one should note is that it has a variable speed control and does not become overly warm while in use. One such vibrator may be purchased at Lover's Lane, located at 43735 Van Dyke Avenue, Sterling Heights, Mich., or can be obtained from the same establishment via the internet at the following URL: http://www.loverslane.com. The model which has been selected for the best characteristics of variable speed and low heat is “IT'S A LIFE SAVER”, Item No. 02 VI PD9050.

In accordance with the present invention, the preferred method in using the infant soothing support device 10 involves opening the cover 30 by unzipping the zipper 32 such that the resilient wedge pad 20 is exposed. Reach through the slit or pad opening 26 and remove the vibrator 40 from the cylindrical cavity 25 of the resilient wedge pad 20. Then activate the vibrator 40 and adjusting the frequency with the speed control 43 to a desired level. The vibrator is then placed into the cylindrical cavity 25 and the cover opening 31 is closed by zipping the zipper 32 closed. The infant soothing support device 10 is now ready for use.

In operation, the infant soothing support device 10 can be placed upon any firm surface such as a crib mattress, a bassinet mattress, the floor, a couch, or the like, and the infant or baby's torso would be placed upon or rested against the infant soothing support device 10, such that the vibrations or movement are transmitted to the infant's torso. As a result, the infant will be supplied with soothing vibrations or movement which will comfort the infant and allow the infant to sleep more deeply and soundly. If the infant is inflicted with congestion or colic the vibrations or movement will also aid in breaking up congestion and providing soothing movement to the infants torso which will in-turn aid in alleviating the symptoms of congestion and colic.

Furthermore, the infant soothing support device 10 may be used while an infant is being held by a caregiver wherein the infant soothing support device 10 is placed between the infant's torso and the caregiver's arm to allow vibration or movement to be transmitted to the infant thereby soothing the infant. A caregiver could also hold the infant soothing support device 10 upon their lap or chest while sitting or laying down and then place the infant's torso upon the support device such that vibration or movement will be transmitted to the infant thereby soothing the infant. Anyway in which an infant is held or laid down, the infant soothing support device can be place between the surface against which the infant is resting and the infant's torso such that vibration or movement will be transmitted to the infant thereby soothing the infant.

A mother may also be able to use this device to aid in the beginning stages of breastfeeding. The soothing vibrations or movement will calm the infant inasmuch to allow a more successful attempt for the infant to “latch-on” to their mother's breast. This has many benefits in that a mother's breast milk is the most nutritious for an infant.

To evaluate the performance of the infant soothing support device's properties that can be obtained in accordance with the teachings of the present invention, a specimen was fabricated for testing. The specimen was given to a hospital's Neonatal Intensive Care Unit (NICU) during the inventor's grandchild's heart and respiratory therapy. The device was used in the infant's crib and placed behind the infant while the infant was laying on their side. A folded towel was placed behind the soothing device to provide support and maintain its position while being used. According to the nurses at the hospital the device was extremely successful in aiding the dispersion of the fluid on the infant's lung and helping to re-inflate the infant's lung. The hospital was using another vibrator which was longer and while running would become hot to the touch. This vibrator was wrapped in a towel and place behind the infant. The issue with this solution was that the vibrator would often vibrate out of the towel and then need to be place back behind the infant in which the nurse would then disturb the infant while sleeping. Further, the vibrator would become too hot to touch. Therefore, if the vibrator moved outside of the towel and came into contact with the infant's skin, would burn the infant from the heat of the vibrator. The proposed invention eliminated this possibility due to the enclosed structure of the pad and the selection of a vibrator which did not heat up while being used.

While the present invention has been described in terms of a preferred embodiment, it is apparent that other forms could be adopted by one skilled in the art. For example the teachings of the present invention encompass any reasonable substitutions or equivalents of claim limitations. Examples include, the material for the resilient wedge pad could be a memory foam, sponge material, or the like. The material used for the cover can be made of a cotton, cotton blend, polyester, or the like. Furthermore, the term infant covers/means infant, child, newborn or the like. Those skilled in the art will appreciate that other applications, including those outside of the health industry, and uses with adults, especially seniors, are possible with this invention. Accordingly, the present invention is not limited to only infants with health issues, but any application which can aid from soothing vibrations or movement while resting. Accordingly, the scope of the present invention is to be limited only by the following claims.

What is claimed is:

1. An infant soothing support device comprising:
a resilient wedge member; and
means for vibrating said resilient wedge member; said vibrating means being integral with said resilient wedge member, whereby a restless, colicky, or congested infant resting upon said resilient wedge member will be soothed by movement of said vibrating means.

2. An infant soothing support device as claimed in claim 1, wherein said resilient wedge member further comprises:
an upper surface;
a lower surface, opposite of said upper surface;
one end; and
an opposite end, whereby said opposite end is thicker than said one end.

3. An infant soothing support device as claimed in claim 1 further comprising a cover member surrounding said resilient wedge member.

4. An infant soothing support device as claimed in claim 1 wherein said means for vibrating said resilient wedge member further comprises a variable speed vibrator.

5. An infant soothing support device as claimed in claim 1 wherein said resilient wedge member is made of pliable foam.

6. An infant soothing support device as claimed in claim 2, wherein said upper surface forms an acute angle with said lower surface, said acute angle beginning at said one end and extending toward said opposite end of said resilient wedge member.

7. An infant soothing support device comprising:
a resilient wedge pad comprising an upper surface; a lower surface opposite of said upper surface; one end; and an opposite end, wherein said opposite end is thicker than said one end, said upper surface forms an acute angle with said lower surface, said acute angle starting at said one end and extending toward said opposite end of said resilient wedge member,
a cover member surrounding said resilient wedge member; and
a variable speed vibrator for vibrating said resilient wedge member, said vibrator being integral with said resilient wedge pad whereby a restless, colicky, or congested infant resting upon said resilient wedge pad will be soothed by movement of said vibrator.

8. An infant soothing support device as claimed in claim 8, wherein said resilient wedge pad further comprises a cavity adjacent to said opposite end, whereby said vibrator is stored within said cavity.

9. An infant soothing support device as claimed in claim 8, wherein said resilient wedge pad is made of a pliable foam.

10. An infant soothing support device as claimed in claim 8, wherein said resilient wedge pad further comprises a pad opening, said pad opening extending from said opposite end into said cavity such that said vibrator is easily accessible.

11. An infant soothing support device as claimed in claim 7 wherein said cover member is in the shape of a pocket and further comprises
a cover opening to allow said resilient wedge pad to be removed or replaced,
means for detachably securing said cover opening such that an infant is unable to open said cover.

12. An infant soothing support device as claimed in claim 7, wherein said cover surrounds said resilient wedge pad in a close fit manner, thereby not allowing said cover to fit loosely around said resilient wedge pad.

13. infant soothing support device as claimed in claim 7, wherein said vibrator further comprises:
a vibrator body;
a cover detachably attached to one end of said vibrator body; and
a variable speed control attached to said cover to provide for control of the frequency and magnitude of vibrations from said vibrator.

14. An infant soothing support device comprising:
a resilient wedge pad comprising an upper surface; a lower surface opposite of said upper surface; one end; and an opposite end, said opposite end is thicker than said one end, said upper surface forms an acute angle with said lower surface, said acute angle starting at said one end and extending toward said opposite end of said resilient wedge pad; a cavity adjacent to said opposite end; a pad opening extending from said opposite end into said cavity such that access to said cavity can be easily made for the purpose of storing a vibrator within said cavity;
a cover member surrounding said resilient wedge pad, said cover member further comprising:
a cover opening to allow said resilient wedge pad to be removed or replaced therein; and
means for detachably securing said cover opening such that an infant is unable to open said cover
a vibrator for vibrating said resilient wedge member, said vibrator being mounted in said cavity of said resilient wedge pad, said vibrator further comprising a vibrator body; a cover detachably attached to one end of said vibrator body; and a speed control means attached to said vibrator cover to allow variable control of the frequency and magnitude of vibrations of said vibrator whereby a restless, colicky, or congested infant resting upon said resilient wedge pad covered by said cover member, will be soothed by movement of said vibrator mounted to said resilient wedge pad.

15. An infant soothing support device as claimed in claim 14, wherein said cavity of said resilient wedge pad is cylindrical in shape and substantially aligned with said opposite end.

16. An infant soothing support device as claimed in claim 14, wherein said resilient wedge pad is made of a pliable foam.

17. An infant soothing support device as claimed in claim 14, wherein said cover member is made of washable cloth.

18. An infant soothing support device as claimed in claim 14, wherein said cover member is close fitting.
